(19) United States
(12) Patent Application Publication
(10) Pub. No.: US 2025/0112008 A1
(43) Pub. Date: Apr. 3, 2025

(54) AUTO ROTATION OF ADJUSTABLE KEY SWITCH

(71) Applicant: Logitech Europe S.A., Lausanne (CH)

(72) Inventors: Feng-Hao Lin, Hsinchu City (TW); Yu-Chun Sun, Taipei City (TW)

(21) Appl. No.: 18/479,050

(22) Filed: Sep. 30, 2023

(51) Int. Cl. H01H 13/7065; G06F 3/02

(52) U.S. Cl. CPC H01H 13/7065; G06F 3/0202; H01H 2221/01; H01H 2221/022; H01H 2235/00

(57) ABSTRACT

A key structure comprising an upper and lower key stem, a rotatable middle key stem including a magnetized element disposed therein, the rotatable middle key stem coupled between and in axial alignment with the upper and lower key stems, and a magnetic field generator configured to steer a magnetic field through the magnetized element of the rotatable middle key stem. The rotatable middle key stem is operable to be longitudinally rotatable between a first and second position, while the upper and lower key stems are rotationally fixed. The generated magnetic field, when at a first setting, applies a first magnetic force on the magnetized element causing the middle key stem to rotate to the first position, and when at a second setting, applies a second magnetic force on the magnetized element causing the middle key stem to rotate to the second position.

### BACKGROUND

Input devices are commonplace in modern society and are typically used to convert human-induced analog inputs (e.g., touches, clicks, motions, touch gestures, button presses, scroll wheel rotations, etc.) made in conjunction with an input device into digital signals for computer processing. An input device can include any device that can provide data and control signals to a computing system. Some non-limiting examples of input devices include computer mice, keyboards, virtual reality and/or augmented reality controllers, touch pads, remote controls, gaming controllers, joysticks, trackballs, and the like. Some non-limiting examples of computing systems include desktop computers, laptop computers, netbook computers, gaming consoles, tablets and “phablet” computers, smart phones, personal digital assistants, wearable devices (e.g., smart watches, glasses), virtual reality (VR) and/or augmented reality (AR) headsets and systems, and the like.

Keyboards, in particular, have undergone many marked improvements over the last several decades. In some contemporary input devices, keyboards can take the form of standalone wired or wireless input controllers, or be integrated with portable electronic devices, such as laptop and tablet computing devices. While input feedback mechanisms vary across conventional designs, each key of a keyboard is generally designed to provide a user with positive confirmation that the key has been actuated. These input feedback mechanisms can differ substantially. For example, feedback mechanisms for basic low-profile keyboards might only include a dome switch or scissor mechanism for each key while more mechanical keyboards can include spring mechanisms that provide a certain amount of linear feedback prior to actuation. Unfortunately, given the large population of users it is difficult to design a keyboard that is well-suited for a large cross-section of users. Better designs are desirable that can accommodate different user preferences and espouse more universal appeal.

### BRIEF SUMMARY OF THE INVENTION

In certain embodiments, a depressible key structure for a keyboard includes: an upper key stem; a lower key stem; a rotatable middle key stem including a magnetized element disposed therein, the rotatable middle key stem coupled between and in axial alignment with the upper and lower key stems, the rotatable middle key stem including a protrusion, wherein the rotatable middle key stem is operable to be longitudinally rotatable between a first and second position while the upper and lower key stems remain longitudinally stationary; a biasing element configured adjacent to the middle key stem; a U-shaped metal bar with a first end and second end, the first and second ends configured adjacent to and on opposite sides of the middle key stem; and a coil having a first side and a second side, the coil coupled to the metal bar, the coil, when energized by a power source, operable to generate a magnetic field, wherein the metal bar conducts the magnetic field from the first side of the coil, to the first end of the metal bar, to the magnetized element of the rotatable middle key stem, to the second end of the metal bar, and to the second side of the coil, making a magnetic circuit, wherein the generated magnetic field, when at a first setting, magnetically manipulates the magnetized element causing the middle key stem to rotate to the first position where the biasing element interfaces with the protrusion when the key structure is depressed causing a first feedback effect, and wherein the generated magnetic field, when at a second setting, magnetically manipulates the magnetized element causing the middle key stem to rotate to the second position where the biasing element bypasses the protrusion when the key structure is depressed resulting in a second feedback effect.

In some embodiments, the key structure further comprising one or more processors operable to control an electrical current flowing through the coil including a first current that sets the generated magnetic field to the first setting, and a second current that sets the generated magnetic field to the second setting. The electrical current flowing through the coil may set a strength and polarity of the generated magnetic field. The key structure may comprise a key cap that is configured to couple to the upper key stem in a complimentary frictional fit relationship. In some aspects, the upper key stem remains longitudinally stationary as the middle key stem rotates between the first and second positions. The first feedback effect can be a clicky feedback effect caused primarily by a movement of the biasing element over contours of the protrusion. In some aspects, the biasing element can be a torsion spring. The key structure can further include a second biasing element (e.g., a coiled spring, helical compression spring) that provides a restoring force that moves the key structure from a depressed position to an unpressed position, wherein the second feedback effect is a linear feedback caused primarily by the restoring force of the second biasing element. In certain embodiments, the lower key stem includes a slotted region having a first wall and a second wall, wherein the rotatable middle key stem incudes a second protrusion that is configured slide within the slotted region as the rotatable middle key stem moves between the first and second positions, wherein when the second protrusion is configured against the first wall within the slotted region when the rotatable middle key stem is in the first position, the first wall of the slotted region being operable to prevent the rotatable middle key stem from longitudinally rotating further in a direction of the first wall, and wherein when the second protrusion is configured against the second wall within the slotted region when the rotatable middle key stem is in the second position, the second wall of the slotted region being operable to prevent the rotatable middle key stem from longitudinally rotating further in a direction of the second wall. In some cases, the slotted region includes a laterally protruding bump configured between the first and second wall that resists movement of the rotatable middle key stem between the first and second positions, wherein the rotatable middle key stem moves between the first and second positions when the magnetic field is at the first setting and above a threshold magnetic field strength or when the magnetic field is at the second setting and above the threshold magnetic field strength. In some embodiments, the first and second ends of the U-shaped metal bar includes laterally extended portions that decrease a distance of the U-shaped metal bar to the rotatable middle key stem. In certain embodiments, the magnetized element is a ferromagnetic slug.

In some embodiments, a key structure comprises: an upper key stem; a lower key stem; a rotatable middle key stem including a magnetized element disposed therein, the rotatable middle key stem coupled between and in axial alignment with the upper and lower key stems, wherein the rotatable middle key stem is operable to be longitudinally rotatable between a first and second position, wherein the upper and lower keys stems are rotationally fixed; a magnetic field generator configured to steer a magnetic field through the magnetized element of the rotatable middle key stem, wherein the generated magnetic field, when at a first setting, applies a first magnetic force on the magnetized element causing the middle key stem to rotate to the first position, and wherein the generated magnetic field, when at a second setting, applies a second magnetic force on the magnetized element causing the middle key stem to rotate to the second position. The key structure can further include one or more processors and a coil operable to generate the generated magnetic field, wherein the one or more processors are operable to control an electrical current flowing through the coil including a first current that sets the generated magnetic field to the first setting, and a second current that sets the generated magnetic field to the second setting. In some embodiments, the upper key stem remains longitudinally stationary as the middle key stem rotates between the first and second positions. The rotatable middle key stem can include a protrusion, wherein a biasing element is configured adjacent to the middle key stem, wherein in the first position the biasing element interfaces with the protrusion when the key structure is depressed causing a first feedback effect, and wherein in the second position the biasing element bypasses the protrusion when the key structure is depressed resulting in a second feedback effect. In some cases, the first feedback effect is a clicky feedback effect caused primarily by a movement of the biasing element over contours of the protrusion. The key structure may further include a second biasing element that provides a restoring force that moves the key structure from a depressed position to an unpressed position, wherein the second feedback effect is a linear-type feedback caused primarily by the restoring force of the second biasing element.

In further embodiments, a keyboard comprises one or more processors; a plurality of depressible key structures, each key structure comprising: an upper key stem; a lower key stem; a rotatable middle key stem including a magnetized element disposed therein, the rotatable middle key stem coupled between and in axial alignment with the upper and lower key stems, the rotatable middle key stem including a protrusion, wherein the rotatable middle key stem is operable to be longitudinally rotatable between a first and second position while the upper and lower keys stems remain longitudinally stationary; a biasing element configured adjacent to the middle key stem; a U-shaped metal bar with a first end and second end, the first and second ends configured adjacent to and on opposite sides of the middle key stem; and a coil having a first side and a second side, the coil coupled to the metal bar, the coil, when energized by a power source, operable to generate a magnetic field, wherein the generated magnetic field, when at a first setting, magnetically manipulates the magnetized element causing the middle key stem to rotate to the first position where the biasing element interfaces with the protrusion when the key structure is depressed causing a first feedback effect, wherein the generated magnetic field, when at a second setting, magnetically manipulates the magnetized element causing the middle key stem to rotate to the second position where the biasing element does not interface with the protrusion when the key structure is depressed causing a second feedback effect, and wherein the one or more processors are operable to control an electrical current flowing through each coil of the plurality of depressible key structures including a first current that sets the generated magnetic field to the first setting, and a second current that sets the generated magnetic field to the second setting.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

FIG. 1 shows an example of a computer system that can include any of a variety of host computing devices and computer peripheral devices, including computer peripheral devices (e.g., a keyboard) that can be configured to perform aspects of the various inventive concepts described herein;

FIG. 2 shows a system for operating a computer peripheral device, according to certain embodiments;

FIG. 3 is a simplified block diagram of a host computing device, according to certain embodiments;

FIG. 4A shows an exploded perspective view of manually adjustable keyswitch system that can produce a feedback profile;

FIG. 4B shows a perspective view of manually adjustable key stem configured with three different protrusions radially offset by about 90 degrees;

FIG. 5 shows an example of an automatically adjustable keyswitch, according to certain embodiments;

FIGS. 6A-6C show an operational sequence of an automatically adjustable keyswitch, according to certain embodiments;

FIG. 7 shows an exploded view of an automatically adjustable keyswitch, according to certain embodiments;

FIGS. 8A-8B show operational aspects of different feedback settings for an auto-adjustable keyswitch, according to certain embodiments;

FIGS. 9A-9C show aspects of key stem retention, according to certain embodiments;

FIG. 10A-10B show aspects of improving a magnetic circuit efficiency, according to certain embodiments; and

FIG. 11 is a simplified flow chart showing aspects of a method for automatically rotating an adjustable keyswitch, according to certain embodiments.

Throughout the drawings, it should be noted that like reference numbers are typically used to depict the same or similar elements, features, and structures.

### DETAILED DESCRIPTION

Aspects of the present disclosure relate generally to computer peripheral devices, and more particularly to systems and methods for auto-rotation of an adjustable keyswitch, according to certain embodiments.

In the following description, various examples of automatically adjusting a feedback setting for an adjustable keyswitch are described. For purposes of explanation, specific configurations and details are set forth to provide a thorough understanding of the embodiments. However, it will be apparent to one skilled in the art that certain embodiments may be practiced or implemented without every detail disclosed. Furthermore, well-known features may be omitted or simplified to mitigate any obfuscation of the novel features described herein.

The following high-level summary is intended to provide a basic understanding of some of the novel innovations depicted in the figures and presented in the corresponding descriptions provided below. Aspects of the invention relate to automatically rotating an adjustable keyswitch, according to certain embodiments. Tactile feedback for keys of a computer peripheral device, such as a keyboard, can be very subjective to the user and different types of key press feedback profiles (e.g., clicky, linear, tactile, etc.) can be found on a variety of keyboard types, including gaming keyboards, productivity keyboards, ergonomic keyboards, and the like. As such, conventional keyboards typically have keys and corresponding keyswitches with one type of key press feedback, thereby requiring users to invest in multiple keyboards if certain types of feedback are preferred for different activities, such as productivity tasks versus gaming. In some contemporary computer peripheral devices, the keyswitch may be manually replaced where a user can either swap out the keyswitch structure for one with a preferred key press feedback profile, or in some cases, manually adjustable where the user can remove the key cap for each key and manually modify (e.g., rotate) each key structure to access different feedback profile types, as found in some Logitech keyboards (see, e.g., U.S. patent application Ser. No. 16/189,698, which is hereby incorporated by reference in its entirety for all purposes). Although the ability to manually change a keyswitch feedback profile can accommodate a much wider range of users and applications, the task of manually swapping or adjusting in some cases over 100 keys can be very tedious, labor intensive, and time consuming. Furthermore, the notion of switching feedback profiles to better accommodate different applications, particularly during a same session, is practically speaking untenable. As such, the value of a system that can automatically adjust (e.g., rotate) one or a plurality of keyswitches to set a different feedback profile, without requiring manual interaction (e.g., removing/replacing keycaps, rotating or swapping keyswitches, etc.), such as the novel embodiments described herein, can be appreciated for not only the time savings of not having to manually change anything, but the prospect of doing so automatically and simultaneously for some or all of the keys on the computer peripheral device, making switching feedback profiles multiple times in a session (e.g., for application specific purposes) realizable.

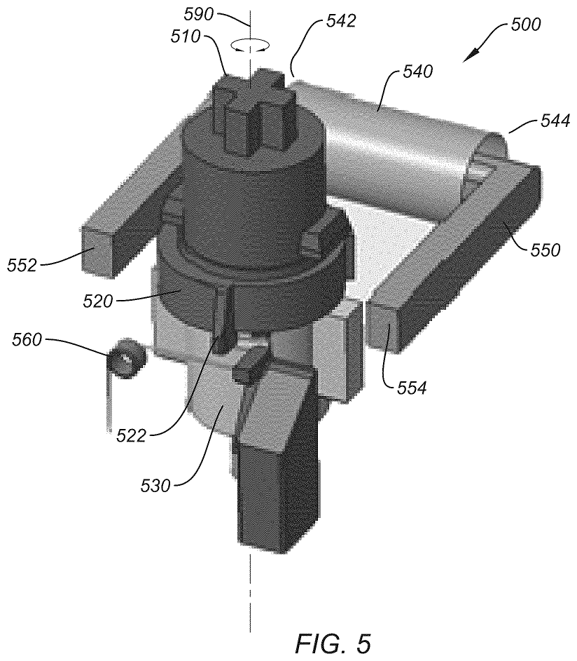

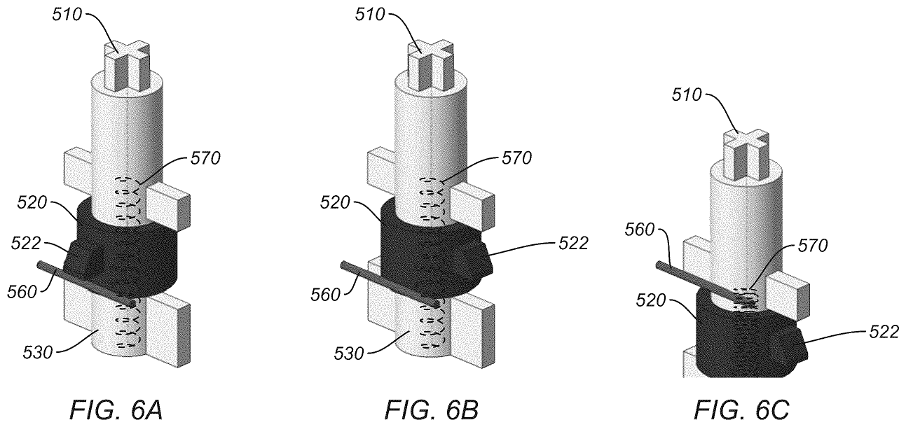

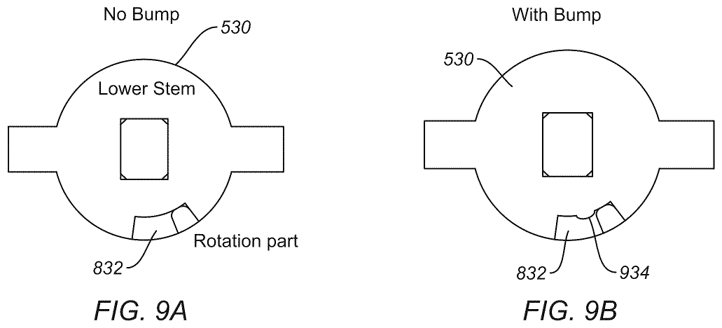

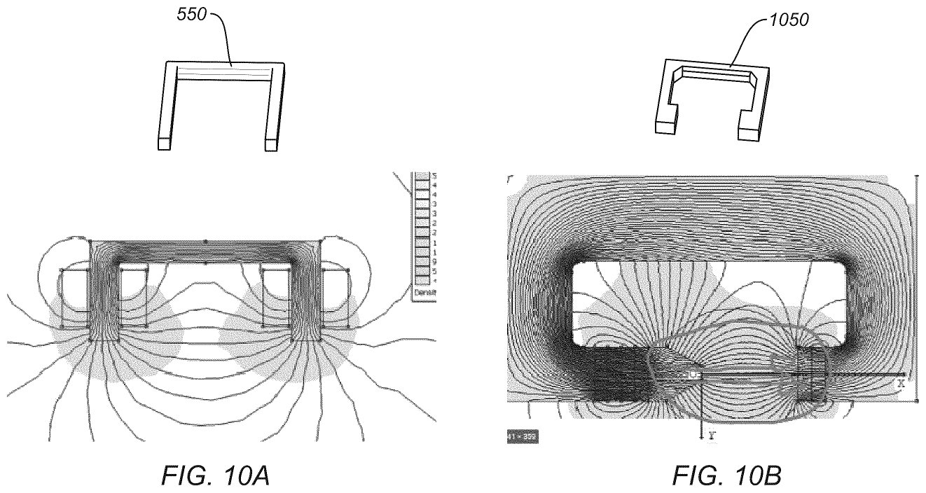

Some embodiments can automatically adjust a feedback profile for one or more keyswitches in a computer peripheral device by rotating an internal portion of the key structure via magnetic control that changes a feedback profile without rotating the keycap. Thus, the user can switch to two or more different feedback profiles without affecting the layout of the keys (e.g., the keycaps and corresponding indicia will not change their orientation). An example of a system for automatically adjusting a feedback profile for a keyswitch is shown in FIG. 5 and described, along with varying embodiments thereof, in FIGS. 6A-10B. To provide a high-level explanation of some of the novel embodiments described herein, a keyswitch can include a rotatable center portion that has multiple configurations, where each configuration has an associated feedback profile that can be realized by an interaction between a biasing mechanism and a contour on the center portion (e.g., a protrusion), as further described in more detail below. Different contours allow for different feedback profiles, as would be appreciated by one of ordinary skill in the art with the benefit of this disclosure. The center portion can be rotated while the top portion that is coupled to the keycap can remain stationary. Rather than manually rotating the center portion to switch between feedback profiles, a magnetic circuit, typically comprised of a power source, a coil, and a ferromagnetic conductor, can generate a magnetic field that is steered to pass through the center portion of the keyswitch. The center portion typically has a magnetized element, such as a metal slug, that is pushed or pulled by the magnetic field, thereby causing the center portion to rotate. Some additional novel features can be used to ensure that the center portion stays in a particular orientation (and corresponding feedback profile) without inadvertently moving (see, e.g., FIGS. 9A-9B), to improve the strength of the magnetic field (see, e.g., FIGS. 10A-10B), and simultaneously rotating some or all of the center portions of a plurality of keyswitches, among other concepts and embodiments that are more fully described and explored throughout the present disclosure.

It is to be understood that this high-level summary is presented to provide the reader with a baseline understanding of some of the novel aspects of the present disclosure and a roadmap to the details that follow. This high-level summary in no way limits the scope of the various embodiments described throughout the detailed description and each of the figures referenced above are further described below in greater detail and in their proper scope.

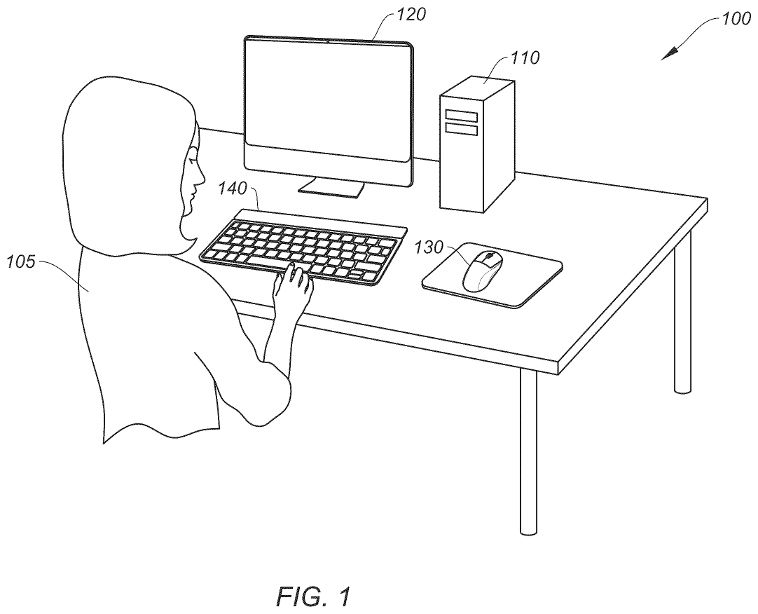

FIG. 1 shows an example of a computer system 100 that can include any of a variety of host computing devices and computer peripheral devices, including computer peripheral devices (e.g., a computer mouse, keyboard, etc.) that can be configured to perform aspects of the various inventive concepts described herein. Computer system 100 shows a user 105 operating a host computing device (shown as a desktop computer) 110 and a number of computer peripheral devices that can be coupled to and/or integrated with the host computing device, including a display device 120, a computer mouse 130, a keyboard 140, and may include any other suitable computer peripheral device (e.g., microphone, speaker(s), docking station, headphones, etc.). Each computer peripheral device 120-140 can be communicatively coupled to host computing device 110.

Although the host computing device is shown as a desktop computer, other types of host computing devices can be used including gaming systems, laptop computers, set top boxes, entertainment systems, tablet or “phablet” computers, stand-alone head mounted displays (“MID”), or any other suitable host computing device (e.g., smart phone, smart wearable, or the like). In some cases, multiple host computing devices may be used and one or more of the computer peripheral devices may be communicatively coupled to one or more of the host computing devices (e.g., a computer mouse may be coupled to multiple host computing devices). A host computing device may also be referred to herein as a “host computer,” “host device,” “computing device,” “computer,” or the like, and may include a machine readable medium (not shown) configured to store computer code, such as driver software, firmware, and the like, where the computer code may be executable by one or more processors of the host computing device(s) to control aspects of the host computing device, for instance via the one or more computer peripheral devices.

A typical computer peripheral device can include any suitable input device, output device or input/output device including those shown (e.g., a keyboard) and not shown (e.g., remote control), wearables (e.g., gloves, watch, head mounted display), AR/VR controller, CAD controller, joystick, simulation shifter, stylus device, or other suitable device that can be used, for example, to convert analog inputs into digital signals for computer processing. By way of example, a computer peripheral device (e.g., computer mouse 130) can be configured to provide control signals for movement tracking (e.g., x-y movement on a planar surface, three-dimensional “in-air” movements, etc.), touch and/or gesture detection, lift detection, orientation detection (e.g., in 3 degrees-of-freedom (DOF) system, 6 DOF systems, etc.), power management capabilities, input detection (e.g., buttons, scroll wheels, etc.), output functions (e.g., LED control, haptic feedback, etc.), or any of myriad other features that can be provided by a computer peripheral device, as would be appreciated by one of ordinary skill in the art. The keys of keyboard 140 (or other depressible element on any input device) may incorporate auto-rotatable keyswitch architectures, as presented herein.

An input device may be a computer peripheral device, and may be referred to as either herein, as well as a “peripheral input device,” “peripheral,” or the like. The majority of the embodiments described herein generally refer to computer peripheral device 140, however it should be understood that a computer peripheral device can be any suitable input/output (I/O) device (e.g., user interface device, control device, input unit, or the like) that may be adapted to utilize the novel embodiments described and contemplated herein.

### A System for Operating a Computer Peripheral Device

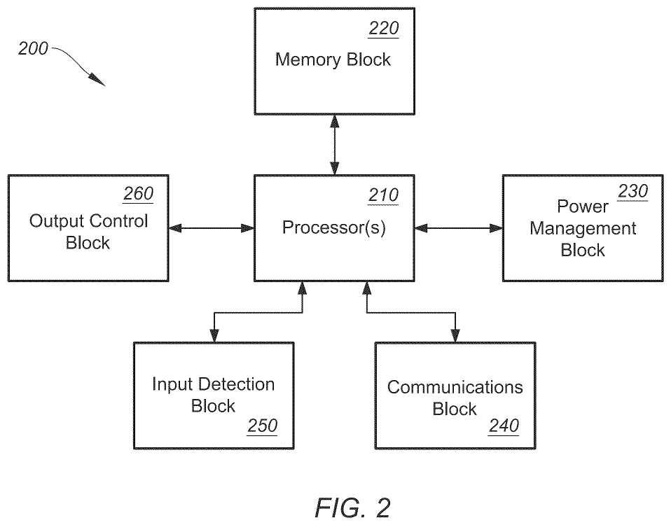

FIG. 2 shows a system 200 for operating a computer peripheral device (e.g., keyboard 140), according to certain embodiments. System 200 may be configured to operate any of the computer peripheral devices specifically shown or not shown herein but within the wide purview of the present disclosure. System 200 may include processor(s) 210, memory block 220, a power management block 230, a communications block 240, an input detection block 250, and an output control block 260. Each of the system blocks 220-260 can be in electronic communication with processor(s) 210 (e.g., via a bus system). System 200 may include additional functional blocks that are not shown or discussed to prevent obfuscation of the novel features described herein. System blocks 220-260 (also referred to as “modules,” “systems,” or “system blocks”) may be implemented as separate modules, or alternatively, more than one system block may be implemented in a single module. In the context described herein, system 200 can be incorporated into any computer peripheral device described or mentioned herein and may be further configured with any of the auto-rotatable key switch architectures presented herein, as described below at least with respect to FIGS. 5-11B, as would be appreciated by one of ordinary skill in the art with the benefit of this disclosure.

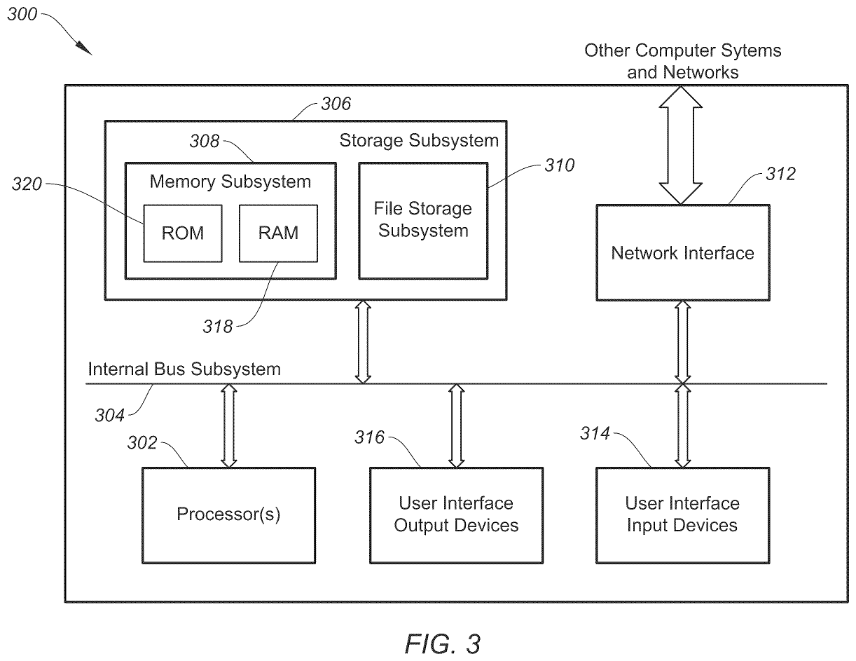

In certain embodiments, processor(s) 210 may include one or more microprocessors and can be configured to control the operation of system 200. Alternatively or additionally, processor(s) 210 may include one or more microcontrollers (MCUs), digital signal processors (DSPs), or the like, with supporting hardware and/or firmware (e.g., memory, programmable I/Os, etc.), and/or software, as would be appreciated by one of ordinary skill in the art. Processor(s) 210 can control some or all aspects of the operation of computer peripheral device 140 (e.g., system block 220-260). Alternatively or additionally, some of system blocks 220-260 may include an additional dedicated processor, which may work in conjunction with processor(s) 210. For instance, MCUs, μCs, DSPs, and the like, may be configured in other system blocks of system 200. Communications block 240 may include a local processor, for instance, to control aspects of communication with host computer 110 (e.g., via Bluetooth, Bluetooth LE, RF, IR, hardwire, ZigBee, Z-Wave, Logitech Unifying, or other communication protocol). Processor(s) 210 may be local to the peripheral device (e.g., contained therein), may be external to the peripheral device (e.g., off-board processing, such as by a corresponding host computing device), or a combination thereof. Processor(s) 210 may perform any of the various functions and methods described and/or covered by this disclosure in conjunction with any other system blocks in system 200. In some implementations, processor 302 of FIG. 3 may work in conjunction with processor 210 to perform some or all of the various methods described throughout this disclosure. In some embodiments, multiple processors may enable increased performance characteristics in system 200 (e.g., speed and bandwidth), however multiple processors are not required, nor necessarily germane to the novelty of the embodiments described herein. One of ordinary skill in the art would understand the many variations, modifications, and alternative embodiments that are possible.

Memory block (“memory”) 220 can store one or more software programs to be executed by processors (e.g., in processor(s) 210). It should be understood that “software” can refer to sequences of instructions that, when executed by processing unit(s) (e.g., processors, processing devices, etc.), cause system 200 to perform certain operations of software programs. The instructions can be stored as firmware residing in read-only memory (ROM) and/or applications stored in media storage that can be read into memory for execution by processing devices (e.g., processor(s) 210). Software can be implemented as a single program or a collection of separate programs and can be stored in non-volatile storage and copied in whole or in-part to volatile working memory during program execution. In some embodiments, memory 220 may store data corresponding to inputs on the peripheral device, such as a detected movement of the peripheral device sensor (e.g., optical sensor, accelerometer, etc.), activation of one or more input elements (e.g., buttons, sliders, touch-sensitive regions, etc.), or the like. Stored data may be aggregated and sent via reports to a host computing device.

In certain embodiments, memory 220 can store the various data described throughout this disclosure. For example, memory 220 can store and/or include instructions configured to perform the various auto-rotation keyswitch controlling schemas presented herein, as described below at least with respect to FIGS. 5-111B. Memory 220 can be used to store any suitable data to perform any function described herein and as would be appreciated by one of ordinary skill in the art with the benefit of this disclosure. Memory array 220 can be referred to as a storage system or storage subsystem, and can store one or more software programs to be executed by processors (e.g., in processor(s) 210). It should be understood that “software” can refer to sequences of instructions that, when executed by processing unit(s) (e.g., processors, processing devices, etc.), cause system 200 to perform certain operations of software programs. The instructions can be stored as firmware residing in read only memory (ROM) and/or applications stored in media storage that can be read into memory for processing by processing devices. Software can be implemented as a single program or a collection of separate programs and can be stored in non-volatile storage and copied in whole or in-part to volatile working memory during program execution. From a storage subsystem, processing devices can retrieve program instructions to execute to run various operations (e.g., software-controlled switches, etc.) as described herein.

Power management system 230 can be configured to manage power distribution, recharging, power efficiency, haptic motor power control, and the like. In some embodiments, power management system 230 can include a battery (not shown), a Universal Serial Bus (USB)-based recharging system for the battery (not shown), and power management devices (e.g., voltage regulators—not shown), and a power grid within system 200 to provide power to each subsystem (e.g., communications block 240, etc.). In certain embodiments, the functions provided by power management system 230 may be incorporated into processor(s) 210. Alternatively, some embodiments may not include a dedicated power management block. For example, functional aspects of power management block 240 may be subsumed by another block (e.g., processor(s) 210) or in combination therewith. The power source can be a replaceable battery, a rechargeable energy storage device (e.g., super capacitor, Lithium Polymer Battery, NiMH, NiCd), a corded power supply, or other suitable power source. The recharging system can be an additional cable (specific for the recharging purpose) or it can use a USB connection to recharge the battery.

Communication system 240 can be configured to enable wireless communication with a corresponding host computing device (e.g., 110), or other devices and/or peripherals, according to certain embodiments. Communication system 240 can be configured to provide radio-frequency (RF), Bluetooth®, Logitech proprietary communication protocol (e.g., Unifying, Gaming Lightspeed, or others), infra-red (IR), ZigBee®, Z-Wave, or other suitable communication technology to communicate with other computing devices and/or peripheral devices. System 200 may optionally comprise a hardwired connection to the corresponding host computing device. For example, input device 140 can be configured to receive a USB, FireWire®, Thunderbolt®, or other universal-type cable to enable bi-directional electronic communication with the corresponding host computing device or other external devices. Some embodiments may utilize different types of cables or connection protocol standards to establish hardwired communication with other entities. In some aspects, communication ports (e.g., USB), power ports, etc., may be considered as part of other blocks described herein (e.g., input detection module 250, output control module 260, etc.). In some aspects, communication system 240 can send reports generated by the processor(s) 210 (e.g., HID data, streaming or aggregated data, etc.) to a host computing device. In some cases, the reports can be generated by the processor(s) only, in conjunction with the processor(s), or other entity in system 200. Communication system 240 may incorporate one or more antennas, oscillators, etc., and may operate at any suitable frequency band (e.g., 2.4 GHz), etc. One of ordinary skill in the art with the benefit of this disclosure would appreciate the many modifications, variations, and alternative embodiments thereof.

Input detection module 250 can control the detection of a user-interaction with input elements (also referred to as “elements”) on an input device. For instance, input detection module 250 can detect user inputs from keys or buttons (e.g., depressible elements), roller wheels, motion sensors, scroll wheels, track balls, touch pads (e.g., one and/or two-dimensional touch sensitive touch pads), click wheels, dials, keypads, microphones, GUIs, touch-sensitive GUIs, proximity sensors (e.g., IR, thermal, Hall effect, inductive sensing, etc.) image sensor based detection such as gesture detection (e.g., via webcam), audio based detection such as voice input (e.g., via microphone), or the like, as would be appreciated by one of ordinary skill in the art with the benefit of this disclosure. Alternatively, the functions of input detection module 250 can be subsumed by processor 210, or in combination therewith.

In some embodiments, input detection module 250 can detect a touch or touch gesture on one or more touch sensitive surfaces on input device 130. Input detection block 250 can include one or more touch sensitive surfaces or touch sensors. Touch sensors generally comprise sensing elements suitable to detect a signal such as direct contact, electromagnetic or electrostatic fields, or a beam of electromagnetic radiation. Touch sensors can typically detect changes in a received signal, the presence of a signal, or the absence of a signal. A touch sensor may include a source for emitting the detected signal, or the signal may be generated by a secondary source. Touch sensors may be configured to detect the presence of an object at a distance from a reference zone or point (e.g., <5 mm), contact with a reference zone or point, or a combination thereof. Certain embodiments of computer peripheral device 150 may or may not utilize touch detection or touch sensing capabilities.

Input detection block 250 can include touch and/or proximity sensing capabilities. Some examples of the types of touch/proximity sensors may include, but are not limited to, resistive sensors (e.g., standard air-gap 4-wire based, based on carbon loaded plastics which have different electrical characteristics depending on the pressure (FSR), interpolated FSR, strain gages, etc.), capacitive sensors (e.g., surface capacitance, self-capacitance, mutual capacitance, etc.), optical sensors (e.g., light barrier type (default open or closed), infrared light barriers matrix, laser-based diode coupled with photo-detectors that could measure the time of flight of the light path, etc.), acoustic sensors (e.g., piezo-buzzer coupled with microphones to detect the modification of a wave propagation pattern related to touch points, etc.), inductive sensors, magnetic sensors (e.g., Hall Effect, etc.), or the like.

In some embodiments, output control module 260 can control various outputs for a corresponding computer peripheral device. For instance, output control module 260 may control a number of visual output elements (e.g., LEDs, LCD screens), displays, audio outputs (e.g., speakers), haptic output systems, or the like. One of ordinary skill in the art with the benefit of this disclosure would appreciate the many modifications, variations, and alternative embodiments thereof.

Although certain systems may not be expressly discussed, they should be considered as part of system 200, as would be understood by one of ordinary skill in the art. For example, system 200 may include a bus system to transfer power and/or data to and from the different systems therein. It should be appreciated that system 200 is illustrative and that variations and modifications are possible. System 200 can have other capabilities not specifically described herein. Further, while system 200 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained.

Embodiments of the present invention can be realized in a variety of apparatuses including electronic devices (e.g., computer peripheral devices) implemented using any combination of circuitry and software. Furthermore, aspects and/or portions of system 200 may be combined with or operated by other sub-systems as required by design. For example, input detection block 250 and/or memory 220 may operate within processor(s) 210 instead of functioning as a separate entity. In addition, the inventive concepts described herein can also be applied to any electronic device. Further, system 200 can be applied to any of the computer peripheral devices described in the embodiments herein, whether explicitly, referentially, or tacitly described (e.g., would have been known to be applicable to a particular computer peripheral device by one of ordinary skill in the art). The foregoing embodiments are not intended to be limiting and those of ordinary skill in the art with the benefit of this disclosure would appreciate the myriad applications and possibilities.

### System for Operating a Host Computing Device

FIG. 3 is a simplified block diagram of a host computing device 300, according to certain embodiments. Host computing device 300 can implement some or all functions, behaviors, and/or capabilities described above that would use electronic storage or processing, as well as other functions, behaviors, or capabilities not expressly described. Host computing device 300 can include a processing subsystem (processor(s)) 302, a storage subsystem 306, user interfaces 314, 316, and a communication interface 312. Computing device 300 can also include other components (not explicitly shown) such as a battery, power controllers, and other components operable to provide various enhanced capabilities. In various embodiments, host computing device 300 can be implemented in any suitable computing device, such as a desktop or laptop computer (e.g., desktop 110), mobile device (e.g., tablet computer, smart phone, mobile phone), gaming console, wearable device, media device, or the like, or in peripheral devices (e.g., keyboards, etc.) in certain implementations.

Processor(s) 302 can include MCU(s), micro-processors, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electronic units designed to perform a function or combination of methods, functions, etc., described throughout this disclosure.

Storage subsystem 306 can be implemented using a local storage and/or removable storage medium, e.g., using disk, flash memory (e.g., secure digital card, universal serial bus flash drive), or any other non-transitory storage medium, or a combination of media, and can include volatile and/or non-volatile storage media. Local storage can include a memory subsystem 308 including random access memory (RAM) 318 such as dynamic RAM (DRAM), static RAM (SRAM), synchronous dynamic RAM (e.g., DDR), or battery backed up RAM or read-only memory (ROM) 320, or a file storage subsystem 310 that may include one or more code modules. In some embodiments, storage subsystem 306 can store one or more applications and/or operating system programs to be executed by processing subsystem 302, including programs to implement some or all operations described above that would be performed using a computer. For example, storage subsystem 306 can store one or more code modules for implementing one or more method steps described herein.

A firmware and/or software implementation may be implemented with modules (e.g., procedures, functions, and so on). A machine-readable medium tangibly embodying instructions may be used in implementing methodologies described herein. Code modules (e.g., instructions stored in memory) may be implemented within a processor or external to the processor. As used herein, the term “memory” refers to a type of long term, short term, volatile, nonvolatile, or other storage medium and is not to be limited to any particular type of memory or number of memories or type of media upon which memory is stored.

Moreover, the term “storage medium” or “storage device” may represent one or more memories for storing data, including read only memory (ROM), RAM, magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, program code or code segments to perform tasks may be stored in a machine readable medium such as a storage medium. A code segment (e.g., code module) or machine-executable instruction may represent a procedure, a function, a subprogram, a program, a routine, a subroutine, a module, a software package, a script, a class, or a combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted by suitable means including memory sharing, message passing, token passing, network transmission, etc. These descriptions of software, firmware, storage mediums, etc., apply to systems 200 and 300, as well as any other implementations within the wide purview of the present disclosure. In some embodiments, aspects of the invention (e.g., surface classification) may be performed by software stored in storage subsystem 306, stored in memory 220 of a computer peripheral device, or both. One of ordinary skill in the art with the benefit of this disclosure would appreciate the many modifications, variations, and alternative embodiments thereof.

Implementation of the techniques, blocks, steps and means described throughout the present disclosure may be done in various ways. For example, these techniques, blocks, steps and means may be implemented in hardware, software, or a combination thereof. For a hardware implementation, the processing units may be implemented within one or more ASICs, DSPs, DSPDs, PLDs, FPGAs, processors, controllers, micro-controllers, microprocessors, other electronic units designed to perform the functions described above, and/or a combination thereof.

Each code module may comprise sets of instructions (codes) embodied on a computer-readable medium that directs a processor of a host computing device 110 to perform corresponding actions. The instructions may be configured to run in sequential order, in parallel (such as under different processing threads), or in a combination thereof. After loading a code module on a general purpose computer system, the general purpose computer is transformed into a special purpose computer system.

Computer programs incorporating various features described herein (e.g., in one or more code modules) may be encoded and stored on various computer readable storage media. Computer readable media encoded with the program code may be packaged with a compatible electronic device, or the program code may be provided separately from electronic devices (e.g., via Internet download or as a separately packaged computer readable storage medium). Storage subsystem 306 can also store information useful for establishing network connections using the communication interface 312.

Computer system 300 may include user interface input devices 314 elements (e.g., touch pad, touch screen, scroll wheel, click wheel, dial, button, switch, keypad, microphone, etc.), as well as user interface output devices 316 (e.g., video screen, indicator lights, speakers, headphone jacks, virtual- or augmented-reality display, etc.), together with supporting electronics (e.g., digital to analog or analog to digital converters, signal processors, etc.). A user can operate input devices of user interface 314 to invoke the functionality of computing device 300 and can view and/or hear output from computing device 300 via output devices of user interface 316.

Processing subsystem 302 can be implemented as one or more processors (e.g., integrated circuits, one or more single core or multi core microprocessors, microcontrollers, central processing unit, graphics processing unit, etc.). In operation, processing subsystem 302 can control the operation of computing device 300. In some embodiments, processing subsystem 302 can execute a variety of programs in response to program code and can maintain multiple concurrently executing programs or processes. At a given time, some or all of a program code to be executed can reside in processing subsystem 302 and/or in storage media, such as storage subsystem 304. Through programming, processing subsystem 302 can provide various functionality for computing device 300. Processing subsystem 302 can also execute other programs to control other functions of computing device 300, including programs that may be stored in storage subsystem 304.

Communication interface (also referred to as network interface) 312 can provide voice and/or data communication capability for computing device 300. In some embodiments, communication interface 312 can include radio frequency (RF) transceiver components for accessing wireless data networks (e.g., Wi-Fi network; 3G, 4G/LTE; etc.), mobile communication technologies, components for short range wireless communication (e.g., using Bluetooth communication standards, NFC, etc.), other components, or combinations of technologies. In some embodiments, communication interface 312 can provide wired connectivity (e.g., universal serial bus (USB), Ethernet, universal asynchronous receiver/transmitter, etc.) in addition to, or in lieu of, a wireless interface. Communication interface 312 can be implemented using a combination of hardware (e.g., driver circuits, antennas, modulators/demodulators, encoders/decoders, and other analog and/or digital signal processing circuits) and software components. In some embodiments, communication interface 312 can support multiple communication channels concurrently.

User interface input devices 314 may include any suitable computer peripheral device (e.g., computer mouse, keyboard, gaming controller, remote control, stylus device, etc.), as would be appreciated by one of ordinary skill in the art with the benefit of this disclosure. User interface output devices 316 can include display devices (e.g., a monitor, television, projection device, etc.), audio devices (e.g., speakers, microphones), haptic devices, etc. Note that user interface input and output devices are shown to be a part of system 300 as an integrated system. In some cases, such as in laptop computers, this may be the case as keyboards and input elements as well as a display and output elements are integrated on the same host computing device. In some cases, the input and output devices may be separate from system 300, as shown in FIG. 1. One of ordinary skill in the art with the benefit of this disclosure would appreciate the many modifications, variations, and alternative embodiments thereof.

It will be appreciated that computing device 300 is illustrative and that variations and modifications are possible. A host computing device can have various functionality not specifically described (e.g., voice communication via cellular telephone networks) and can include components appropriate to such functionality. While the computing device 300 is described with reference to particular blocks, it is to be understood that these blocks are defined for convenience of description and are not intended to imply a particular physical arrangement of component parts. For example, processing subsystem 302, storage subsystem 306, user interfaces 314, 316, and communications interface 312 can be in one device or distributed among multiple devices. Further, the blocks need not correspond to physically distinct components. Blocks can be configured to perform various operations, e.g., by programming a processor or providing appropriate control circuitry, and various blocks might or might not be reconfigurable depending on how an initial configuration is obtained. Embodiments of the present invention can be realized in a variety of apparatus including electronic devices implemented using a combination of circuitry and software. Host computing devices or even peripheral devices described herein can be implemented using system 300.

As described above, some contemporary computer peripheral devices, such as keyboards, may incorporate keyswitches that may be manually replaced where a user can either swap out the keyswitch structure for one with a preferred key press feedback profile, or in some cases, manually adjustable where the user can remove the key cap for each key and manually modify (e.g., rotate) each key structure to access different feedback profile types. Although the ability to manually change a keyswitch feedback profile can accommodate a much wider range of users and applications, the task of manually swapping or adjusting many keys can be very tedious, labor intensive, and time consuming, and may often need special tools to make the change, remove/replace the keycap, or the like.

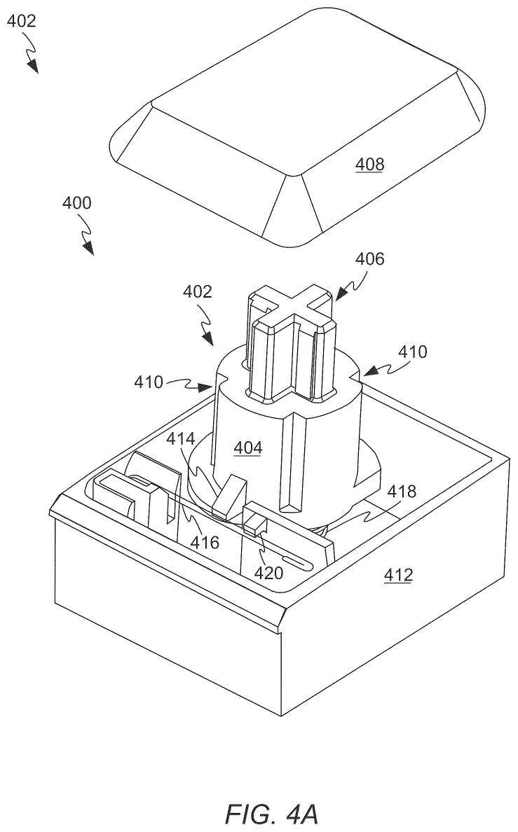

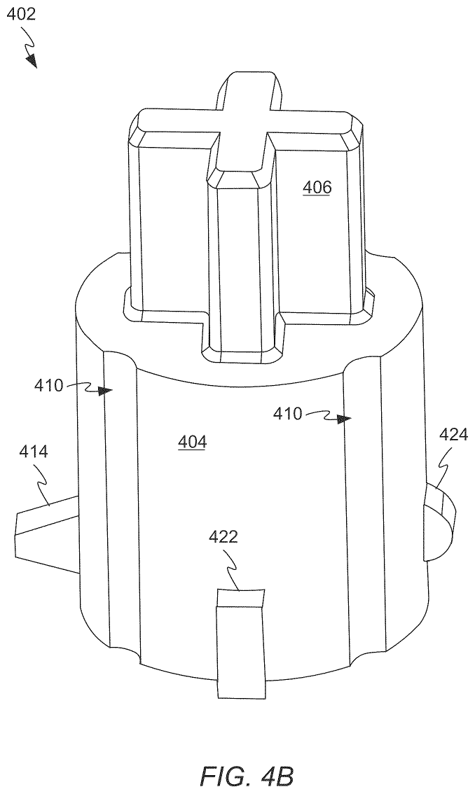

FIG. 4A shows an exploded perspective view of manually adjustable keyswitch system (architecture) 400 that can produce a feedback profile. Keyswitch system 400 includes key stem 402 having a key stem body 404 with a substantially cylindrical geometry. A keycap attachment feature 406 protrudes axially from one end of key stem body 404. Keycap attachment feature 406 has a cross-shaped geometry as depicted that is configured to engage a complementary cross-shaped recess in keycap 408. Interaction between keycap attachment feature 406 and the recess in keycap 408 prevents rotation of keycap 408 relative to key stem 402. While a cross-shaped geometry of keycap attachment feature 406 is depicted, any non-circular geometry capable of preventing rotation of keycap 408. Keycap attachment feature 406 could also be engaged by a tool configured to assist a user with adjusting a feedback response of key assembly 102. A lateral exterior surface of key stem body 404 defines multiple channels 410 that are aligned with a longitudinal axis of key stem body 404. Channels 410 are configured to be engaged by one or more detents that engages channels 410 to create discrete rotational positions for key stem 402 relative to a housing component 412. These discrete positions help to align radial protrusion 414 with torsional spring 416 when key stem 402 is in a first position.

FIG. 4A also shows how torsional spring 416 is held in position relative to key stem 402 by a recess defined by housing component 412. Key stem 402 is supported within housing component 412 by a helical compression spring 418. Helical compression spring 418 can be configured to provide a linear feedback response to a user through key stem 402 and keycap 408. However, once protrusion 414 engages torsion spring 416 a resistance encountered by a user input increases. In some embodiments, the leg of torsion spring 416 engaged with protrusion 414 can slide around protrusion 414 and become disengaged from protrusion 414 providing a reduction in resistance, resulting in a user receiving a tactile indication that the user input has been received. In other embodiments, torsion spring 416 can remain engaged with protrusion 414 until an electrical contact or other electrical signal device is tripped. Housing component 412 also includes a spring stop 420 that preloads torsion spring 416. In this way, an initial amount of force imparted by torsional spring 416 can be stronger than it would otherwise be if torsion spring 416 were not being preloaded by spring stop 420. While not specifically depicted in FIG. 4A it should be appreciated that a second undepicted leg of torsion spring 416 can engage an interior-facing surface of a wall of housing component 412.

FIG. 4B shows a perspective view of manually adjustable key stem 402 configured with three different protrusions 414, 422 and 424 radially offset by about 90 degrees. Channels 410 are shown interspersed between each of protrusions 414, 422 and 424. Channels 410 extend from a first end of key stem body 404 to a second end of key stem body 404 opposite the first end. The generous length of channels 410 allows a detent engaging one or more of channels 410 to remain engaged during axial movement of key stem body 404. It should be noted that protrusions 414, 422 and 424 all have different shapes and sizes. Interaction between the different shapes and sizes of the various protrusions changes the feedback response provided by torsional spring 416. For example, protrusion 424 is positioned higher up on key stem body 404 than protrusions 414 and 422. For this reason, a user actuating key assembly 102 is able to press the keycap farther down before encountering a larger force provided by the torsional spring. Furthermore, the curved shape of protrusion 424 also effects the overall feel of the feedback response. In particular, protrusion 424 provides a tactile feedback response, protrusion 422 provides an additional linear feedback response and protrusion 414 provides a more defined click feedback response to a user input.

FIG. 5A shows an example of an automatically adjustable keyswitch (“keyswitch”) 500, according to certain embodiments. Keyswitch 500 can a portion of a larger key structure for an input device (e.g., keyboard 140), which can include a frame, support hardware, etc., for supporting a plurality of auto-adjustable keyswitches. An example of a larger assembly including said frame and support hardware is shown in FIG. 5B, however the features of FIG. 5A are more germane to the present disclosure, and are unobstructed to better convey the inventive concepts presented herein.

Keyswitch 500 can include a key stem comprised on an upper key stem 510, a middle key stem 520, and a lower key stem 530, according to certain embodiments. The upper key stem 510 can include a keycap attachment feature that can allow the upper keycap 510 to couple to a keycap in a complimentary frictional fit relationship, or other suitable coupling method, as would be appreciated by one of ordinary skill in the art with the benefit of this disclosure. In some aspects, the rotatable middle key stem 520 can rotate longitudinally (e.g., along its vertical axis 590 and is in co-axial alignment with the upper and lower key stems. Upper key stem 520 may be operable to rotate between a plurality of positions including a first position and a second position (or more), while the upper key stem 510 and lower key stem 530 remain stationary, such that a rotation of middle key stem 520 does not cause a rotation of the corresponding keycap. In some embodiments, middle key stem 520 may have a first protrusion 522 having a laterally extending contour at the first position and no protrusion at the second position, as shown for instance in FIGS. 6A-6C. In some aspects, the second position (and any number of additional positions) may also have protrusions of different contours to allow a variety of feedback profiles, like shown in FIG. 4B. One of ordinary skill in the art with the benefit of this disclosure would appreciate the many modifications, variations, and alternative embodiments thereof.

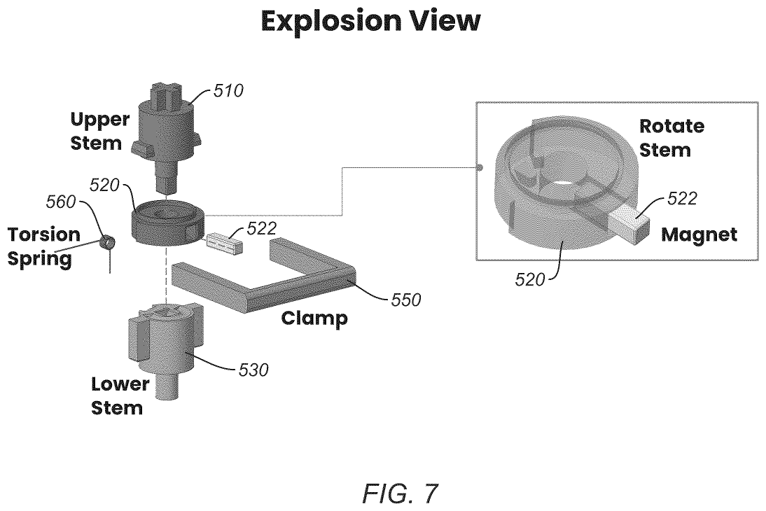

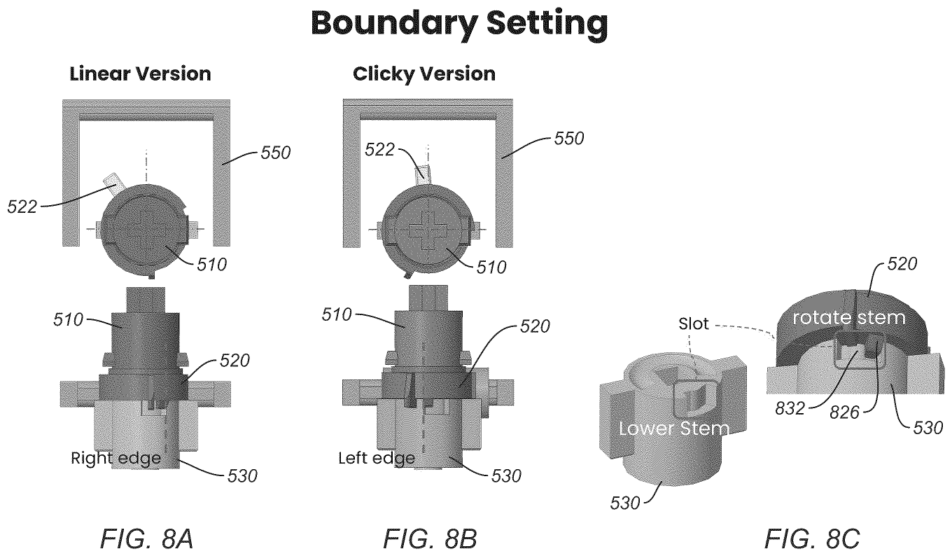

In some aspects, middle key stem 520 may include a magnetized (or magnetizable) element, such as a metal slug (or other ferromagnetic element), disposed within (see, e.g., FIGS. 7-8C), that may cause middle key stem 520 to rotate clockwise or counter-clockwise when exposed to a magnetic field caused by a magnetizing assembly, as further described below. The key stem can be depressible along vertical axis 590 (see, e.g., FIG. 6C) and may be configured to trigger a sensor or switch that generates a control signal that corresponds to a keypress, as would be appreciated by one of ordinary skill in the art with the benefit of this disclosure.

In some embodiments, keyswitch 500 can include a magnetizing assembly including a power source (not shown), a coil 540, and a metal bar 550. The current source may be controlled by one or more processors 210 and can be operable to drive a current through coil 540, thereby energizing coil 540 and causing it to generate a magnetic field. The magnetic field strength and polarity of the magnetic field can depend on the magnitude and polarity of the current driving coil 540. Metal bar 550 can be U-shaped, as shown, circular, or any other polygon, shape, or the like that is operable to conduct a magnetic field generated by coil 540 through and adjacent to middle key stem 520, as further described below and shown in FIGS. 8A-8B and 10A-10B. Metal bar 550 can include a first end 552 and second end 554 that are configured adjacent to and on opposite sides of middle key stem 520.

In operation, the power source energizes coil 540 that generates a magnetic field, wherein metal bar 540 conducts the magnetic field from first terminal 542 of coil 540 to the first end 552 of metal bar 550, through the magnetized element of the rotatable middle key stem, to second end 554 of metal bar 550, and to the second end 544 of coil 540, thereby completing the magnetic circuit. The magnetic field can manipulate the magnetized element causing the middle key stem to rotate between the positions. When middle key stem 520 is in the first position and the keyswitch 500 is depressed, a biasing mechanism (e.g., torsion spring) comes into contact with first protrusion 522, causing a particular feedback profile through the throw (e.g., some or all) of the key press that is based on the interaction of the biasing mechanism with the contour of first protrusion 522, the biasing characteristics (e.g., stiffness, physical dimensions, etc.) of the biasing mechanism, and in some cases a second biasing mechanism (not shown, but see e.g., biasing mechanism 570 of FIGS. 6A-6C), which provides a restoring force that moves the depressed keyswitch 500 back to a neutral (unpressed) state, as would be appreciated by one of ordinary skill in the art with the benefit of this disclosure. In some aspects, the feedback profile of the first position provides a “clicky” or “tactile” type feedback.

When middle key stem 520 is in the second position (see, e.g., FIGS. 6B-6C) and the keyswitch 500 is depressed, a biasing mechanism (e.g., torsion spring) bypasses the first protrusion 522, causing a particular feedback profile through the throw (e.g., some or all) of the key press that is based primarily on the second biasing mechanism 570 (e.g., helicoidal spring), which provides the restoring force for a linear-type feedback profile, as would be appreciated by one of ordinary skill in the art with the benefit of this disclosure, and in some aspects is similar to the operational description of the key stems in FIGS. 4A-4B (in terms of feedback profiles) and further described below.

FIGS. 6A-6C show an operational sequence of simplified model of an automatically adjustable keyswitch 500, according to certain embodiments. Keyswitch 500 includes upper key stem 510, middle key stem 520 with protrusion 522, lower key stem 530, biasing mechanism 560 and second biasing mechanism 570, as shown in FIGS. 5A and 5B. In FIG. 6A, middle key stem 520 is magnetically manipulated to rotate to a first position where protrusion 522 is configured to interface with biasing mechanism 560 when keyswitch 500 is depressed, as described above. Middle key stem 520 may include a magnetic slug or other ferromagnetic element that is coupled to or embedded within middle key stem 520 that, when subject to a magnetic field, causes middle key stem 520 to rotate based on a strength and polarity of the magnetic field. When the magnetic field is configured in a first setting, the middle key stem 520 moves to the first position. As described above, when keyswitch 500 is depressed in this position, the feedback profile can be defined by the interaction of protrusion 522 with biasing mechanism 560 and the restoring force of second biasing mechanism 570.

In FIG. 6B, middle key stem 520 is magnetically manipulated to rotate to a second position where protrusion 522 is not aligned with biasing mechanism 560, thereby allowing protrusion 522 to bypass biasing mechanism 560 when keyswitch 500 is depressed, as shown in FIG. 6C. When the magnetic field is configured in a second setting, the middle key stem 520 moves to the second position. As described above, when keyswitch 500 is depressed in this position, the feedback profile can be defined largely by the restoring force of second biasing mechanism 570. The embodiment depicted through this disclosure show a magnetically induced middle key stem, however other implementations can be used to rotate between positions, including motors or manual controls, as would be appreciated by one of ordinary skill in the art with the benefit of this disclosure.

FIG. 7 shows an exploded view of aspects of an automatically adjustable keyswitch 500, according to certain embodiments. Keyswitch 500 can be similar to the keyswitches presented in FIGS. 5-6C described above. Although the embodiments presented is the present disclosure show and describe specific implementations of components of keyswitch 500, other components may be used that fall within the wide purview of the inventive concepts presented herein. For instance, magnetic element 522 may be in the form of a bar (as shown), or in any suitable shape that can be coupled to middle key stem 520 or integrated therewith. Exemplary embodiments typically extend magnetic element 522 laterally from middle key stem 520 to create a stronger moment arm such that a weaker magnetic field (and thus less power consumption) can be used to move middle key stem 520 between its multiple positions and corresponding feedback profiles. Metal bar 550 can be u-shaped, c-shaped, or any suitable shape that can operate to steer a magnetic field through or adjacent to middle key stem 520 to induce its rotation between the multiple positions. Middle key stem 520 may rotate between any number of positions with corresponding protrusions having any suitable shape to achieve any desired feedback profile. One of ordinary skill in the art with the benefit of this disclosure would appreciate the many modifications, variations, and alternative embodiments thereof. In some aspects, coil 540 may be one or more coils and the combination of the metal bar and coil may operate as an electromagnet (e.g., requiring constant current draw to maintain the magnetic field). In some cases, power may only be required when switching between positions. In such cases, some retention mechanisms may be used to ensure that middle key stem 520 stays in a current position when no magnetic field is present (see, e.g., FIG. 8C-9B), although some embodiment may remain in their set position without any additional retention mechanism when the magnetic field is removed. In some embodiments, an electropermanent magnet system can be used to generate a programmed and constant magnetic field, and only requiring a momentary power draw (e.g., <100 ms) to set the magnetic field, which is maintained after power is removed, as would be appreciated by one of ordinary skill in the art with the benefit of this disclosure. In some cases one or a plurality of biasing mechanisms can be used, including different types of biasing mechanisms (e.g., torsion, helicoidal, etc.), as would be appreciated by one of ordinary skill in the art with the benefit of this disclosure.

FIGS. 8A-8B show operational aspects of different feedback settings for an auto-adjustable keyswitch 500, according to certain embodiments. FIGS. 8A-8B show how rotational boundaries can be set for middle key stem 520 using a second protrusion 826 that interfaces with a slot 832 having first and second walls in bottom key stem 530. Note that second protrusion 826 is used for boundary setting rather than feedback profile use, however some embodiments may have protrusions that can perform both functions. In FIG. 8A, middle key stem 520 is configured in the second position, causing a linear feedback profile due primarily to the return force provided by second biasing mechanism 570 (not shown, but see, e.g., FIGS. 6A-6C). In the second position, second protrusion 826 moves within slot 832 of bottom key stem 530 until it contacts the second wall, thereby stopping further rotation of middle key stem 520. In FIG. 8B, middle key stem 520 is configured in the first position, causing a “clicky” feedback profile due primarily to the interaction of protrusion 522 with biasing mechanism 560, as well as the return force provided by second biasing mechanism 570. In the first position, second protrusion 826 moves within slot 832 until it contacts the first wall, thereby stopping further rotation of middle key stem 520. FIG. 8C shows a close up view of slot 832, protrusion 826, and the interplay between the two as middle key stem 520 rotates relative to bottom key stem 530. Such embodiments help limit the rotation of middle key stem 520 and ensure that each operational position is properly aligned with or away from the biasing mechanism when the keyswitch is depressed. In certain embodiments, slot 832 can control the boundary or rotation for middle key stem 520, making sure the magnet is on one side of the key stem center so when a magnetic field is activated the magnetic element of the middle key stem can be rotated, which may not occur when the magnetic element is aligned with the magnetic field.

In some embodiments, boundaries can help align middle key stem 520 relative to bottom key stem 530 to ensure proper alignment to achieve a desired feedback profile, as described above. Some embodiments may employ additional features that prevent middle key stem 520 from migrating between positions due to device vibration or the like. In some cases, bumps, ramps, detents, or other features in slot 832 can be used to prevent protrusion 826 and thereby middle key stem 520 from inadvertently moving from its current set position, yet not with too much retention that it prevents intentional changes in position via the magnetic field.

FIGS. 9A-9B show aspects of key stem retainment, according to certain embodiments. In FIG. 9A, no retainment mechanism is used. In such cases, middle key stem 520 may inadvertently rotate between positions if no sufficient rotation friction is present between protrusion 826 and slot 832, or between middle key stem 520 and bottom or top key stems 530/510. FIG. 9B shows a laterally protruding bump 934 configured between the first and second wall that resists movement of the rotatable middle key stem between the first and second positions. Bump 934 can provide sufficient resistance to inadvertent rotation of middle key stem 520, but not too much such that a magnetic field can still rotate middle key stem 520 between positions. In some cases, ramps or bumps configured in different ways (positioned vertically rather than radially). One of ordinary skill in the art with the benefit of this disclosure would appreciate the many modifications, variations, and alternative embodiments thereof.

FIG. 10A-10B show aspects of improving magnetic circuit efficiency, according to certain embodiments. Metal bar 550 can be configured to steer a magnetic field to pass through or adjacent to middle key stem 520 and corresponding magnetic element 522. By reducing a distance between and metal bar ends 552, 554 and magnetic element 522. FIG. 10A shows a U-shaped metal bar 550. FIG. 10B shows a U-shaped metal bar 1050 with extended portions that reduce the distance between metal bar 1050 and magnetic element 522, thereby increasing the efficiency of the transfer of magnetic energy between them. As such, less power can be used to generate the magnetic field and still control the rotation of middle key stem 520 between operational positions.

In some embodiments, one or more processors can cause the feedback profiles for multiple keys to change at the same time, as described above. For example, feedback profiles for keys can be changed for all keys, or staged over groups of keys to reduce any spikes in power consumption. Such groups can be based on zones of the keyboard, key usage (e.g., based on heat map), or the like. In some cases, each key may have one or more associated LEDs that can be programmed to be illuminated in a manner (e.g., temporarily, continuously) that indicates a particular feedback profile setting so the user can quickly identify if all intended keys are set correctly. In some cases, haptics can be associated with some or all of the keys and may operate in a similar manner (e.g., vibrating to provide tactile feedback that informs the user of what feedback profile is selected). One of ordinary skill in the art with the benefit of this disclosure would appreciate the many modifications, variations, and alternative embodiments thereof. In some cases, keyswitch 500 can be hot swappable, where the user can remove and replace keyswitches as needed. In some cases, the key caps can be replaceable.

In some exemplary embodiments, a depressible key structure for a keyboard includes: an upper key stem; a lower key stem; a rotatable middle key stem including a magnetized element disposed therein, the rotatable middle key stem coupled between and in axial alignment with the upper and lower key stems, the rotatable middle key stem including a protrusion, wherein the rotatable middle key stem is operable to be longitudinally rotatable between a first and second position while the upper and lower key stems remain longitudinally stationary; a biasing element configured adjacent to the middle key stem; a U-shaped metal bar with a first end and second end, the first and second ends configured adjacent to and on opposite sides of the middle key stem; and a coil having a first side and a second side, the coil coupled to the metal bar, the coil, when energized by a power source, operable to generate a magnetic field, wherein the metal bar conducts the magnetic field from the first side of the coil, to the first end of the metal bar, to the magnetized element of the rotatable middle key stem, to the second end of the metal bar, and to the second side of the coil, making a magnetic circuit, wherein the generated magnetic field, when at a first setting, magnetically manipulates the magnetized element causing the middle key stem to rotate to the first position where the biasing element interfaces with the protrusion when the key structure is depressed causing a first feedback effect, and wherein the generated magnetic field, when at a second setting, magnetically manipulates the magnetized element causing the middle key stem to rotate to the second position where the biasing element bypasses the protrusion when the key structure is depressed resulting in a second feedback effect.

In some embodiments, the key structure further comprising one or more processors operable to control an electrical current flowing through the coil including a first current that sets the generated magnetic field to the first setting, and a second current that sets the generated magnetic field to the second setting. The electrical current flowing through the coil may set a strength and polarity of the generated magnetic field. The key structure may comprise a key cap that is configured to couple to the upper key stem in a complimentary frictional fit relationship. In some aspects, the upper key stem remains longitudinally stationary as the middle key stem rotates between the first and second positions. The first feedback effect can be a clicky feedback effect caused primarily by a movement of the biasing element over contours of the protrusion. In some aspects, the biasing element can be a torsion spring. The key structure can further include a second biasing element (e.g., a coiled spring, helical compression spring) that provides a restoring force that moves the key structure from a depressed position to an unpressed position, wherein the second feedback effect is a linear feedback caused primarily by the restoring force of the second biasing element. In certain embodiments, the lower key stem includes a slotted region having a first wall and a second wall, wherein the rotatable middle key stem incudes a second protrusion that is configured slide within the slotted region as the rotatable middle key stem moves between the first and second positions, wherein when the second protrusion is configured against the first wall within the slotted region when the rotatable middle key stem is in the first position, the first wall of the slotted region being operable to prevent the rotatable middle key stem from longitudinally rotating further in a direction of the first wall, and wherein when the second protrusion is configured against the second wall within the slotted region when the rotatable middle key stem is in the second position, the second wall of the slotted region being operable to prevent the rotatable middle key stem from longitudinally rotating further in a direction of the second wall. In some cases, the slotted region includes a laterally protruding bump configured between the first and second wall that resists movement of the rotatable middle key stem between the first and second positions, wherein the rotatable middle key stem moves between the first and second positions when the magnetic field is at the first setting and above a threshold magnetic field strength or when the magnetic field is at the second setting and above the threshold magnetic field strength. In some embodiments, the first and second ends of the U-shaped metal bar includes laterally extended portions that decrease a distance of the U-shaped metal bar to the rotatable middle key stem. In certain embodiments, the magnetized element is a ferromagnetic slug.

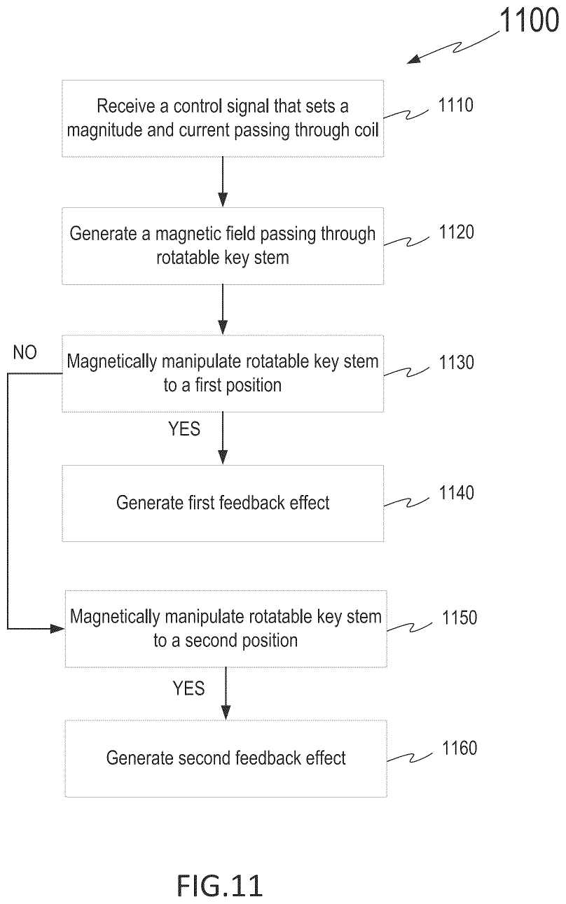

FIG. 11 is a simplified flow chart showing aspects of a method 1100 for automatically rotating an adjustable keyswitch, according to certain embodiments. Method 1100 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 1100 can be performed by aspects of system 200 (e.g., processors 210), or a combination thereof.

At operation 1110, method 1100 can include receiving, from one or more processors, a control signal that sets a polarity and magnitude of a current passing through a conductive coil, causing a generation of a magnetic field according to one of a plurality of settings (operation 1120), according to certain embodiments.

At operation 1130 of method 1100, the generated magnetic field, when at a first setting of the plurality of settings, magnetically manipulates a rotatable key stem having a protrusion to rotate to a first position where a biasing element (e.g., torsion spring) configured adjacent to the rotatable middle key stem interfaces with the protrusion when the key structure is depressed, thereby causing a first feedback effect (operation 1140).

At operation 1150 of method 1100, the generated magnetic field, when at a second setting of the plurality of settings, magnetically manipulates the rotatable key stem to rotate to a second position where the biasing element bypasses the protrusion when the key structure is depressed, thereby causing a second feedback effect (operation 1160). The rotatable key stem can have an upper key stem, a lower key stem, and a middle key stem, wherein the middle key stem rotates in response to the magnetic field and the upper key stem and/or the lower key stem remain stationary. The rotatable middle key stem coupled between and in axial alignment with the upper and lower key stems. The generated magnetic field is generated by a coil that is energized by a power source controlled by the one or more processors, the generated magnetic field being conducted via a u-shaped metal bar with a first end and second end, the first and second ends configured adjacent to and on opposite sides of the middle key stem such that the conducted magnetic field passes through the middle key switch. The rotatable middle key stem is manipulated by the generated magnetic field because the rotatable middle key stem includes a magnetized element (e.g., ferromagnetic slug) coupled thereto that is pushed and/or pulled by the magnetic field, causing the rotation of the middle key stem. In some aspects, the first feedback effect is a clicky feedback effect caused primarily by a movement of the biasing element over contours of the protrusion. In some cases, the key structure further includes a second biasing element that provides a restoring force that moves the key structure from a depressed position to an unpressed position, wherein the second feedback effect is a linear feedback caused primarily by the restoring force of the second biasing element.

It should be appreciated that the specific steps illustrated in FIG. 11 provide a particular method 1100 for automatically rotating an adjustable keyswitch, according to certain embodiments. Other sequences of steps may also be performed according to alternative embodiments. Furthermore, additional steps may be added or removed depending on the particular application. Any combination of changes can be used and one of ordinary skill in the art with the benefit of this disclosure would understand the many variations, modifications, and alternative embodiments thereof.

In some aspects, the various computer peripheral devices described herein can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connections to other computing devices such as network input/output devices may be employed.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A depressible key structure for a keyboard, the key structure comprising:
an upper key stem;
a lower key stem;
a rotatable middle key stem including a magnetized element disposed therein, the rotatable middle key stem coupled between and in axial alignment with the upper and lower key stems, the rotatable middle key stem including a protrusion,
wherein the rotatable middle key stem is operable to be longitudinally rotatable between a first and second position while the upper and lower key stems remain longitudinally stationary;
a biasing element configured adjacent to the middle key stem;
a U-shaped metal bar with a first end and second end, the first and second ends configured adjacent to and on opposite sides of the middle key stem; and
a coil having a first side and a second side, the coil coupled to the metal bar, the coil, when energized by a power source, operable to generate a magnetic field,
wherein the metal bar conducts the magnetic field from the first side of the coil, to the first end of the metal bar, to the magnetized element of the rotatable middle key stem, to the second end of the metal bar, and to the second side of the coil, making a magnetic circuit,
wherein the generated magnetic field, when at a first setting, magnetically manipulates the magnetized element causing the middle key stem to rotate to the first position where the biasing element interfaces with the protrusion when the key structure is depressed causing a first feedback effect, and
wherein the generated magnetic field, when at a second setting, magnetically manipulates the magnetized element causing the middle key stem to rotate to the second position where the biasing element bypasses the protrusion when the key structure is depressed resulting in a second feedback effect.

2. The key structure of claim 1 further comprising one or more processors operable to control an electrical current flowing through the coil including a first current that sets the generated magnetic field to the first setting, and a second current that sets the generated magnetic field to the second setting.

3. The key structure of claim 2 wherein the electrical current flowing through the coil sets a strength and polarity of the generated magnetic field.

4. The key structure of claim 1 further comprising a key cap that is configured to couple to the upper key stem in a complimentary frictional fit relationship.

5. The key structure of claim 1 wherein the upper key stem remains longitudinally stationary as the middle key stem rotates between the first and second positions.

6. The key structure of claim 1 wherein the first feedback effect is a clicky feedback effect caused primarily by a movement of the biasing element over contours of the protrusion.

7. The key structure of claim 1 wherein the biasing element is a torsion spring.

8. The key structure of claim 1 further comprising a second biasing element that provides a restoring force that moves the key structure from a depressed position to an unpressed position, wherein the second feedback effect is a linear feedback caused primarily by the restoring force of the second biasing element.

9. The key structure of claim 1 wherein the second biasing element is a coiled spring.

10. The key structure of claim 1 wherein the lower key stem includes a slotted region having a first wall and a second wall, wherein the rotatable middle key stem incudes a second protrusion that is configured slide within the slotted region as the rotatable middle key stem moves between the first and second positions,
wherein when the second protrusion is configured against the first wall within the slotted region when the rotatable middle key stem is in the first position, the first wall of the slotted region being operable to prevent the rotatable middle key stem from longitudinally rotating further in a direction of the first wall, and
wherein when the second protrusion is configured against the second wall within the slotted region when the rotatable middle key stem is in the second position, the second wall of the slotted region being operable to prevent the rotatable middle key stem from longitudinally rotating further in a direction of the second wall.

11. The key structure of claim 10 wherein the slotted region includes a laterally protruding bump configured between the first and second wall that resists movement of the rotatable middle key stem between the first and second positions,
wherein the rotatable middle key stem moves between the first and second positions when the magnetic field is at the first setting and above a threshold magnetic field strength or when the magnetic field is at the second setting and above the threshold magnetic field strength.

12. The key structure of claim 1 wherein the first and second ends of the U-shaped metal bar includes laterally extended portions that decrease a distance of the U-shaped metal bar to the rotatable middle key stem.

13. The key structure of claim 1 wherein the magnetized element is a ferromagnetic slug.

14. A key structure comprising:
an upper key stem;
a lower key stem;
a rotatable middle key stem including a magnetized element disposed therein, the rotatable middle key stem coupled between and in axial alignment with the upper and lower key stems,
wherein the rotatable middle key stem is operable to be longitudinally rotatable between a first and second position,
wherein the upper and lower keys stems are rotationally fixed;
a magnetic field generator configured to steer a magnetic field through the magnetized element of the rotatable middle key stem,
wherein the generated magnetic field, when at a first setting, applies a first magnetic force on the magnetized element causing the middle key stem to rotate to the first position, and
wherein the generated magnetic field, when at a second setting, applies a second magnetic force on the magnetized element causing the middle key stem to rotate to the second position.

15. The key structure of claim 14 further comprising:
one or more processors; and
a coil operable to generate the generated magnetic field,
wherein the one or more processors are operable to control an electrical current flowing through the coil including a first current that sets the generated magnetic field to the first setting, and a second current that sets the generated magnetic field to the second setting.

16. The key structure of claim 14 wherein the upper key stem remains longitudinally stationary as the middle key stem rotates between the first and second positions.

17. The key structure of claim 14 wherein the rotatable middle key stem includes a protrusion,
wherein a biasing element is configured adjacent to the middle key stem,
wherein in the first position the biasing element interfaces with the protrusion when the key structure is depressed causing a first feedback effect, and
wherein in the second position the biasing element bypasses the protrusion when the key structure is depressed resulting in a second feedback effect.

18. The key structure of claim 17 wherein the first feedback effect is a clicky feedback effect caused primarily by a movement of the biasing element over contours of the protrusion.

19. The key structure of claim 17 further comprising a second biasing element that provides a restoring force that moves the key structure from a depressed position to an unpressed position, wherein the second feedback effect is a linear-type feedback caused primarily by the restoring force of the second biasing element.

20. A keyboard comprising:
one or more processors;
a plurality of depressible key structures, each key structure comprising:
an upper key stem;
a lower key stem;
a rotatable middle key stem including a magnetized element disposed therein, the rotatable middle key stem coupled between and in axial alignment with the upper and lower key stems, the rotatable middle key stem including a protrusion,
wherein the rotatable middle key stem is operable to be longitudinally rotatable between a first and second position while the upper and lower keys stems remain longitudinally stationary;
a biasing element configured adjacent to the middle key stem;
a U-shaped metal bar with a first end and second end, the first and second ends configured adjacent to and on opposite sides of the middle key stem; and
a coil having a first side and a second side, the coil coupled to the metal bar, the coil, when energized by a power source, operable to generate a magnetic field,
wherein the generated magnetic field, when at a first setting, magnetically manipulates the magnetized element causing the middle key stem to rotate to the first position where the biasing element interfaces with the protrusion when the key structure is depressed causing a first feedback effect,
wherein the generated magnetic field, when at a second setting, magnetically manipulates the magnetized element causing the middle key stem to rotate to the second position where the biasing element does not interface with the protrusion when the key structure is depressed causing a second feedback effect, and
wherein the one or more processors are operable to control an electrical current flowing through each coil of the plurality of depressible key structures including a first current that sets the generated magnetic field to the first setting, and a second current that sets the generated magnetic field to the second setting.
